(19) United States
(12) Patent Application Publication
(10) Pub. No.: US 2025/0055608 A1
(43) Pub. Date: Feb. 13, 2025

(54) HARQ STATE FOR RRC CONFIGURATION FOR MULTI-TB SCHEDULING

(71) Applicant: Nokia Technologies Oy, Espoo (FI)

(72) Inventors: Ping Ping WEN, Shanghai (CN); Ping YUAN, Beijing (CN); Jing Yuan SUN, Beijing (CN); Tzu-Chung HSIEH, Hoffman Estates, IL (US)

(21) Appl. No.: 18/798,921

(22) Filed: Aug. 9, 2024

(30) Foreign Application Priority Data
Aug. 11, 2023 (WO) PCT/CN2023/112756

(51) Int. Cl. H04L 1/1867; H04L 1/1812; H04W 72/231

(52) U.S. Cl. CPC H04L 1/1887; H04W 72/231; H04L 1/1812

(57) ABSTRACT

Example embodiments of the present disclosure relate to a terminal device, a network device, methods, apparatuses, and a computer readable storage medium for HARQ state for RRC configuration for multi-TB scheduling. In the solution, a terminal device may receive information which schedules multiple TBs and indicating multiple HARQ processes, the terminal device may further determine a same HARQ state for all of the multiple HARQ processes based on a configured HARQ state of a specific HARQ process in the multiple HARQ processes. As such, a same HARQ state may be applied for all scheduled TBs. Therefore, a flexibility on scheduling is provided, in addition, the DRX behavior for multi-TB scheduling is simplified.

### FIELD

Example embodiments of the present disclosure generally relate to the field of telecommunication and in particular, to devices, methods, apparatuses, and a computer readable storage medium for hybrid automatic repeat request (HARQ) state for radio resource control (RRC) configuration for multi-transport block (TB) scheduling.

### BACKGROUND

Non-terrestrial communication can be regarded as a complementary manner to terrestrial deployments where satellite connectivity can provide coverage beyond terrestrial deployments. The third generation partner project (3GPP) has defined a work item for release 17 (R17) on non-terrestrial networks (NTN) and a work item for R18 on internet of things (IoT)-NTN performance enhancements, where HARQ enabled/disabled is one important feature in both work items.

The benefit of disabling HARQ feedback for NTN and IoT over NTN is to enable the gNB to reuse an HARQ process ID before a full HARQ round trip time (RTT) has elapsed, to avoid the HARQ stalling and reduce the transmission latency as well as enable peak throughput. However, some details on HARQ states should be further studied.

### SUMMARY

In general, example embodiments of the present disclosure provide a solution for HARQ state for RRC configuration for multi-TB scheduling.

In a first aspect, there is provided a terminal device. The terminal device comprises at least one processor and at least one memory storing instructions that, when executed by the at least one processor, cause the terminal device at least to: receive, from a network device, information scheduling a plurality of TBs and indicating a plurality of HARQ processes; determine a configured HARQ state of a specific HARQ process in the plurality of HARQ processes; and determine that all of the plurality of HARQ processes have a same HARQ state being the configured HARQ state of the specific HARQ process.

In a second aspect, there is provided a network device. The network device comprises at least one processor and at least one memory storing instructions that, when executed by the at least one processor, cause the network device at least to: determine a plurality of HARQ processes comprising a specific HARQ process with a configured HARQ state; and transmit, to a terminal device, information scheduling a plurality of TBs and indicating the plurality of HARQ processes.

In a third aspect, there is provided a method performed by a terminal device. The method comprises: receiving, from a network device, information scheduling a plurality of TBs and indicating a plurality of HARQ processes; determining a configured HARQ state of a specific HARQ process in the plurality of HARQ processes; and determining that all of the plurality of HARQ processes have a same HARQ state being the configured HARQ state of the specific HARQ process.

In a fourth aspect, there is provided a method performed by a network device. The method comprises: determining a plurality of HARQ processes comprising a specific HARQ process with a configured HARQ state; and transmitting, to a terminal device, information scheduling a plurality of TBs and indicating the plurality of HARQ processes.

In a fifth aspect, there is provided an apparatus. The apparatus comprises: means for receiving, from a network device, information scheduling a plurality of TBs and indicating a plurality of HARQ processes; means for determining a configured HARQ state of a specific HARQ process in the plurality of HARQ processes; and means for determining that all of the plurality of HARQ processes have a same HARQ state being the configured HARQ state of the specific HARQ process.

In a sixth aspect, there is provided an apparatus. The apparatus comprises: means for determining a plurality of HARQ processes comprising a specific HARQ process with a configured HARQ state; and means for transmitting, to a terminal device, information scheduling a plurality of TBs and indicating the plurality of HARQ processes.

In a seventh aspect, there is provided a terminal device. The terminal device comprises: receiving circuitry configured to receive, from a network device, information scheduling a plurality of TBs and indicating a plurality of HARQ processes; determining circuitry configured to determine a configured HARQ state of a specific HARQ process in the plurality of HARQ processes; and determining circuitry configured to determine that all of the plurality of HARQ processes have a same HARQ state being the configured HARQ state of the specific HARQ process.

In an eighth aspect, there is provided a network device. The network device comprises: determining circuitry configured to determine a plurality of HARQ processes comprising a specific HARQ process with a configured HARQ state; and transmitting circuitry configured to transmit, to a terminal device, information scheduling a plurality of TBs and indicating the plurality of HARQ processes.

In a ninth aspect, there is provided a non-transitory computer readable medium comprising program instructions for causing an apparatus to perform at least the method in any of the third to fourth aspects.

In a tenth aspect, there is provided a computer program comprising instructions, which, when executed by an apparatus, cause the apparatus at least the method in any of the third to fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIGS. 1A-1B illustrate schematic graphs of multiple TBs scheduled by downlink control information (DCI);

FIG. 2 illustrates an example of a network environment in which some example embodiments of the present disclosure may be implemented;

FIG. 3 illustrates an example of a process flow in accordance with some example embodiments of the present disclosure;

FIG. 4 illustrates another example of a process flow of signalling in accordance with some example embodiments of the present disclosure;

FIG. 5 illustrates a flowchart of a method implemented at a terminal device in accordance with some example embodiments of the present disclosure;

FIG. 6 illustrates a flowchart of a method implemented at a network device in accordance with some example embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware, and
   (ii) any portions of hardware processor(s) with software (including digital signal processor(s)), software, and memory(ies) that work together to cause an apparatus, such as a mobile phone or server, to perform various functions; and
(c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT), Non-terrestrial network (NTN), IoT over NTN, and so on. Furthermore, the communications in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

There is specification for multiple TB scheduling that Multi-TBs (such as 1, 2, 4, 6, 8) are scheduled by one DCI in IoT in terrestrial network (TN), where each TB related to one separate HARQ process and the HARQ process IDs will be indicated in the DCI. For example, multiple TBs scheduled by one DCI may be transmitted consecutively or interleaved.

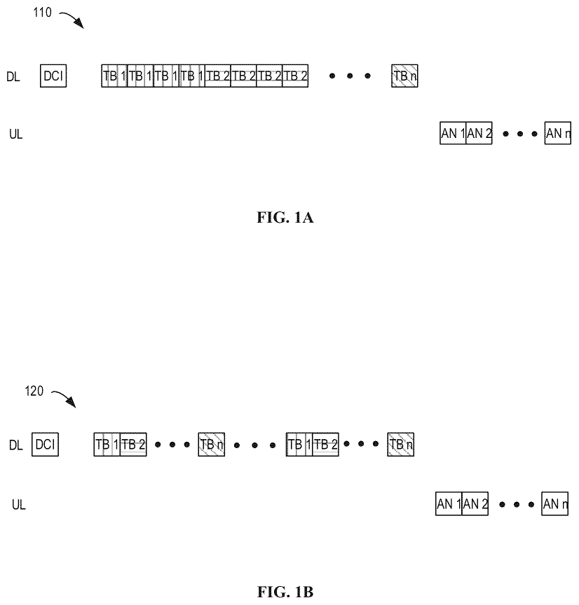

FIG. 1A illustrates a schematic graph 110 of multiple TBs scheduled by a DCI with a contiguous transmission, and FIG. 1B illustrates a schematic graph 120 of multiple TBs scheduled by a DCI with an interleaved transmission. Specifically, one DCI is used for scheduling multiple downlink (DL) or uplink (UL) TBs, where “AN” in FIGS. 1A-1B refers to acknowledgement or negative acknowledgement. For example, for unicast, there may be up to 8 TBs for enhanced machine type communication (eMTC), e.g., 8 for coverage enhancement (CE) Mode A, 4 for CE Mode B; and there may be up to 2 TBs for NB-IoT. For example, for multicast, there may be up to 8 TBs for eMTC and NB-IoT. Specifically, the number of scheduled TBs is indicated by the DCI, and the TBs scheduled by one DCI may use the same resource assignment, MCS and repetition number.

In some examples, the DCI which schedules multiple TBs may be referred to as a DCI for multi-TB scheduling.

When multiple TBs are scheduled for NB-IoT, drx-InactivityTimer will be (re) started when all HARQ RTT Timers (corresponding to HARQ processes belong to the same multi-TB scheduling) have expired for both UL and DL. Additionally, for both NB-IoT and eMTC, (UL) HARQ RTT timers for all HARQ processes corresponding to the scheduled TBs are started in the subframe containing the last repetition of the (PUSCH transmission) PDSCH reception of the last scheduled TB. Some example detailed discontinuous reception (DRX) behavior on multi-TB scheduling may be found in the content in the box below.

```
When DRX is configured, the MAC entity shall for each subframe:
  - if a HARQ RTT Timer expires in this subframe:
    - if the data of the corresponding HARQ process was not successfully decoded:
      - start the drx-RetransmissionTimer or drx-RetransmissionTimerShortTTI
      for the corresponding HARQ process;
  - if NB-IoT:
    - if lower layers had indicated multiple TBs were scheduled for the associated
    expired HARQ RTT Timer:
      - start or restart drx-InactivityTimer when all HARQ RTT Timers have
      expired;
    - else:
      - start or restart the drx-InactivityTimer.
••••••.
if the PDCCH indicates a DL transmission or if a DL assignment has been configured for
this subframe:
  - if the UE is an NB-IoT UE, a BL UE or a UE in enhanced coverage:
    - if lower layers have indicated scheduling of transmission of multiple TBs:
      - start the HARQ RTT Timers for all HARQ processes corresponding to the
      scheduled TBs in the subframe containing the last repetition of the PDSCH
      corresponding to the last scheduled TB;
    - else:
      - start the HARQ RTT Timer for the corresponding HARQ process in the
      subframe containing the last repetition of the corresponding PDSCH
      reception;
••••••
if the PDCCH indicates a new transmission (DL, UL or SL):
  - except for an NB-IoT UE configured with a single DL and UL HARQ process and
  when PDCCH indicates the transmission is not for multiple TBs:
    - start or restart drx-InactivityTimer.
  - if the PDCCH indicates a transmission (DL, UL) for an NB-IoT UE:
    - if the NB-IoT UE is configured with a single DL and UL HARQ process; or
    - if the PDCCH indicates the transmission is for multiple TBs:
      - stop drx-InactivityTimer.
```

As mentioned, HARQ enabled/disabled is an important feature in NTN communication. In NR NTN, disabling HARQ feedback for downlink transmission is semi-static configured by RRC signalling. The configuration is indicated per HARQ process index by a bitmap manner, e.g., 32 bit bitmap if the configured HARQ process number is 32. The network can configure the same or different HARQ feedback state (i.e., HARQ feedback disabling or HARQ feedback enabling) for each HARQ process considering many factors such as reliability, throughput, scheduling efficacy, power consumption etc. In addition, there will be different operations on DRX for HARQ feedback disabling/enabling agreed in NR NTN as below:
For HARQ feedback disabled: the DRX HARQ RTT timer will not be started, which means the network may continue scheduling the retransmission or new transmission without waiting an RTT time length to get the decoding results of the transmissions.
For HARQ feedback enabled: drx-HARQ-RTT-TimerDL length is increased by UE-gNB RTT. In this case, the network needs to wait an RTT time length to get the decoding result of the transmission therefore schedule the retransmission or new transmission based on the decoding results.

In IoT over NTN, HARQ feedback disabling/enabling discussion is ongoing. Both HARQ feedback enabling and disabling was agreed to be supported to guarantee the reliability of some important medium access control (MAC) control element (CE) and RRC signalling as well as avoid HARQ stalling.

Due to the number of HARQ processes in IoT and eMTC may be smaller than the NR UE, e.g., at most 2 HARQ processes for NB-IoT, 4 HARQ processes for eMTC CE mode B, there may need large signalling on reconfiguration HARQ feedback enabling/disabling if re-using the NR NTN solution. Therefore, dynamic HARQ feedback enabling/disabling is discussed for IoT over NTN. The content in the following box are some related agreements in 3GPP radio access network group 1 (RAN1) on HARQ feedback enabling/disabling.

For NB-IoT NTN and eMTC NTN for CE Mode B, to configure/indicate
enabling/disabling of HARQ feedback for downlink transmission:

| | |
|---|---|
| • | Support Option 1 in case only per-HARQ process bitmap signaling is configured. |
| • | Support Option 3 DCI direct indication of HARQ feedback enable/disable in case |

only DCI solution enabling/disabling signaling is configured.

| | |
|---|---|
| • | Support Option 3 DCI indication to override Option 1 configuration for |

```
  corresponding transmission in case both per-HARQ process bitmap and DCI solution
  enabling/disabling signaling are configured.
```

| ∘ | FFS #1: Option 3 DCI-based overridden mechanism is applied to both semi- |
|---|---|
| statically HARQ feedback enabled and disabled processes or only applied to semi- | |
| statically HARQ feedback disabled processes or only applied to semi-statically | |
| HARQ feedback enabled processes. | |
| ∘ | FFS #2: whether/how to support Option 3 overriding Option 1 configuration |
| for corresponding transmission for multiple TBs scheduled by single DCI | |
| ∘ | FFS#3: Option 3 DCI-based overridden mechanism is DCI signaling to |

reverse the HARQ feedback enable/disable for the corresponding transmission
from per-HARQ process RRC configuration or DCI signaling to directly indicate
the HARQ feedback enable/disable for the corresponding transmission regardless
of per-HARQ process RRC configuration.

RAN1 strives to have a common design (in terms of DCI design, PDCCH monitoring, etc.)
for “Option 3” and “Option 3 + Option 1”.
For eMTC NTN, to configure/indicate enabling/disabling of HARQ feedback for downlink
transmission, take Option 1 for CE Mode A.

The agreement in RAN1 is to support both Option1 (i.e., per HARQ process via UE specific RRC signaling in a semi-static way) and Option3 (i.e., explicitly indicated by DCI dynamically) to disable/enable HARQ feedback for NB-IoT and eMTC CE mode B. Both option1 and option3 can be configured by the NW. DCI signaling directly indicates the HARQ feedback enable/disable for the corresponding transmission in case DCI solution enabling/disabling signaling (option3) is configured and per-HARQ process bitmap signaling (option1) is not configured. In some events, it is agreed that for NB-IoT and LTE-MTC in CE Mode B, if multiple TBs are configured, for DCI-based HARQ enabling/disabling direct indication in multiple TBs scheduled by single DCI, the same indication is applied to all scheduled TBs, i.e., HARQ is enabled or disabled for all TBs.

In some situations, if only Option1 (i.e., per HARQ process via UE specific RRC signaling in a semi-static way) is configured. it is possible that some HARQ processes are configured as HARQ feedback disabled and some HARQ processes are configured as feedback enabled for multi-TB scheduling. For the HARQ process with DL HARQ feedback enabled, the HARQ RTT timer length is increased by an offset equal to UE-gNB RTT. For HARQ process with DL HARQ feedback disabled, the UE will not start the corresponding DL HARQ RTT timer. In this event, the DRX related operation on multiple TB scheduling will not be suitable since the current specified condition for NB-IoT to start or restart drx-Inactivity Timer is “when all HARQ RTT Timers have expired” and the drx-Inactivity Timer will not be started or restarted due to DL HARQ RTT timer is not started for the HARQ processes with DL HARQ feedback disabled. Therefore, at least for the DRX related operation, the detailed solution on how to use option 1 should be studied further.

Example embodiments of the present disclosure provide a solution for a HARQ state determination for multi-TB scheduling. In the solution, a terminal device may receive information which schedules multiple TBs and indicating multiple HARQ processes, the terminal device may further determine a same HARQ state for all of the multiple HARQ processes based on a configured HARQ state of a specific HARQ process in the multiple HARQ processes. As such, a same HARQ state may be applied for all scheduled TBs. Therefore, a flexibility on scheduling is provided, in addition, the DRX behavior for multi-TB scheduling is simplified. Principles and some example embodiments of the present disclosure will be described in detail below with reference to the accompanying drawings.

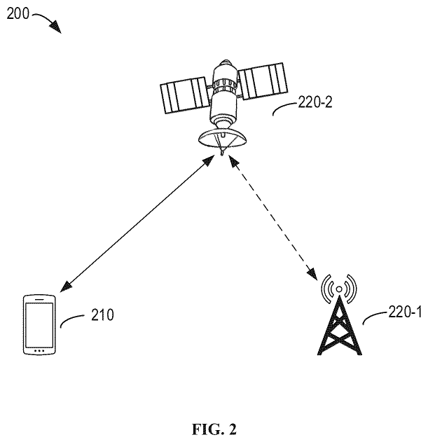

FIG. 2 illustrates an example of a network environment 200 in which some example embodiments of the present disclosure may be implemented. The network environment 200 may also be called as a network system, a communication environment, a communication network, a communication system, or the like, the present disclosure does not limit this aspect. In some example embodiments, the network environment 200 may be implemented as an NTN.

The network environment 200 may include a terminal device 210 and a network device 220 which may include a network device 220-1 on the ground and/or a communication satellite 220-2.

In some implementations, the network device 220 includes the communication satellite 220-2, which may operate as a gNB, or in other words, the gNB (on board) may locate in the communication satellite 220-2. In some examples, the terminal device 210 may be located within coverage of the communication satellite 220-2, for example, the coverage may be called as a NTN cell. In some examples, the communication satellite 220-2 may communicate with a gateway device associated with a 5G core network (CN), which is not shown in FIG. 2.

In some implementations, the network device 220 includes the network device 220-1 on the ground and the communication satellite 220-2. In some examples, the communication satellite 220-2 may operate as a passive or transparent network relay node between the terminal device 210 and a network device 220-1 on the ground. In some embodiments, the communication satellite 220-2 may communicate with the terminal device 210 via a service link or a wireless interface, and communicate with the network device 220-1 on the ground via a feeder link or a wireless interface.

In some embodiments, the communication satellite 220-2 may include a geosynchronous orbit (GEO) satellite, a low earth orbit (LEO) satellite, or another type of satellite. In some embodiments, the satellite 220-2 may pertain to one or more satellite systems or architectures, such as a global navigation satellite system (GNSS), a global positioning system (GPS), a global navigation satellite system (GLONASS), a BeiDou navigation satellite system (BDS), etc.

It is to be understood that the network environment 200 shown in FIG. 2 is only for the purpose of illustration without suggesting any limitation as to the scope of the disclosure. For example, while FIG. 2 depicts the terminal device 210 as a mobile phone, the terminal device 210 may be any type of user equipment.

It is to be understood that the numbers of devices (i.e., the terminal device 210, the network device 220) and their connection relationships and types shown in FIG. 2 are only for the purpose of illustration without suggesting any limitation. The network environment 200 may include any suitable numbers of devices adapted for implementing embodiments of the present disclosure.

In the present disclosure, the term “HARQ state” may also be referred to as a HARQ state in downlink or a HARQ state in uplink. In the present disclosure, the HARQ state in downlink may be a HARQ feedback state, a state of HARQ feedback, or the like, which may be HARQ feedback disabling (disabled), or HARQ feedback enabling (enabled). In the present disclosure, the HARQ state in uplink may be a HARQ mode state, a state of HARQ mode, or the like, which may be HARQ mode A, or HARQ mode B.

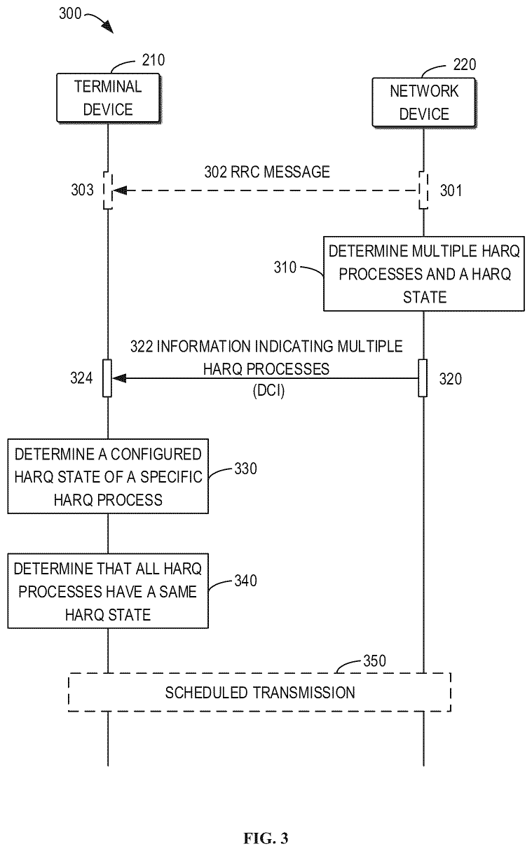

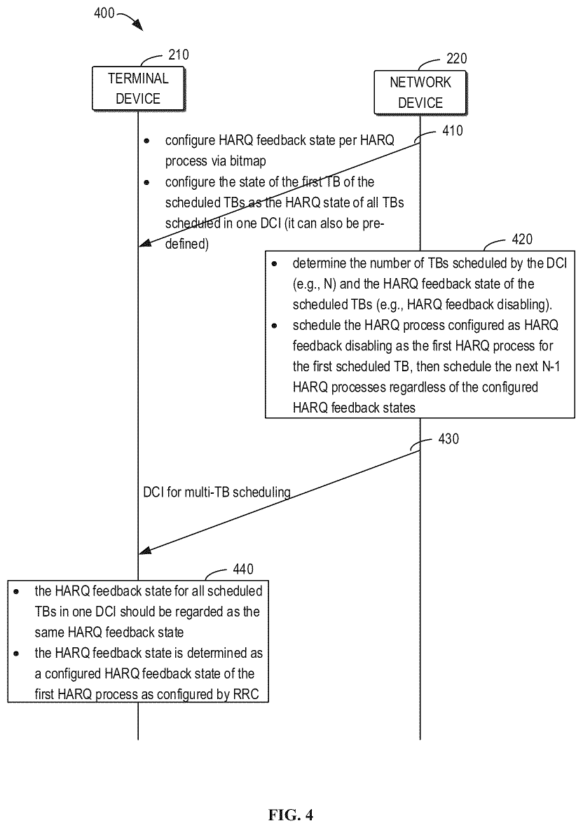

With reference to FIG. 3, which illustrates an example of a process flow 300 in accordance with some example embodiments of the present disclosure. For the purpose of discussion, the process flow 300 will be described with reference to FIG. 2. The process flow 300 involves the terminal device 210 and the network device 220. It would be appreciated that although the process flow 300 has been described in the network environment 200 of FIG. 2, this process flow may be likewise applied to other communication scenarios.

As shown in FIG. 3, the network device 220 may transmit 301 an RRC message 302 to the terminal device 210, accordingly, the terminal device 210 may receive 303 the RRC message 302. In some example embodiments, the RRC message 302 may also be called as an RRC configuration, an RRC configuration message, or the like.

In some example embodiments, the RRC message 302 may include a bitmap, which indicate a group of HARQ states corresponding to a group of HARQ processes. In other words, the network device 220 may configure the HARQ state per HARQ process via a bitmap. In some examples, per-HARQ process bitmap signaling is configured by the network device 220, for example, a case that Option 1 only is configured.

It is assumed that HARQ states in downlink may be configured. As an example, it is assumed that 4 HARQ processes have been configured with different HARQ feedback states for eMTC CE mode B as below:
HARQ process ID 0: HARQ feedback disabling;
HARQ process ID 1: HARQ feedback enabling;
HARQ process ID 2: HARQ feedback disabling; and
HARQ process ID 3: HARQ feedback enabling.

It is to be understood that the example is only for illustration without any limitation, some other examples are also suitable which are not listed herein.

In the process 300, the network device 220 determines 310 multiple HARQ processes, where the multiple HARQ processes include a specific HARQ process with a configured HARQ state.

In some implementations, the network device 220 may determine a number of multiple TBs to be scheduled, for example, the number of TBs may be represented as N, which is a positive integer. For example, N may be one of: 1, 2, 4, 6, 8, or another integer. In some examples, the multiple TBs are scheduled for NB-IoT over NTN, eMTC CE mode A over NTN, eMTC CE mode B over NTN, or NR over NTN, the present disclosure does not limit this aspect.

In some implementations, the network device 220 may determine a specific HARQ state for the multiple TBs, that is, the multiple TBs will apply a same HARQ state. In some examples, take HARQ state in downlink as an example, the specific HARQ state may be HARQ feedback enabling or may be HARQ feedback disabling. In some other examples, take HARQ state in uplink as an example, the specific HARQ state may be HARQ Mode A or may be HARQ Mode B.

In some implementations, the network device 220 may determine (or select) a specific HARQ process which has been configured with the specific HARQ state. As an example mentioned above, if the specific HARQ state is determined as “HARQ feedback disabling”, then HARQ process ID 0 or HARQ process ID 2 may be selected as the specific HARQ process. As an example mentioned above, if the specific HARQ state is determined as “HARQ feedback enabling”, then HARQ process ID 1 or HARQ process ID 3 may be selected as the specific HARQ process.

In some implementations, the network device 220 may determine multiple HARQ processes corresponding to the multiple TBs, where the multiple HARQ processes include the specific HARQ process, and the specific HARQ process is at a specific location in the multiple HARQ processes. In some examples, the specific HARQ process is corresponding to a specific TB in the multiple TBs, for example, specific HARQ process is corresponding to the first TB, the mth TB, the middle TB, or the last TB in the multiple TBs.

In some examples, the multiple HARQ processes may be ordered, and the specific HARQ process is at a specific location in the order. In some implementations, the specific location may be the first location in the order, the last location in the order, a mth location in the order, or a middle location in the order.

It is to be understood that there is an agreement on the specific location at which the specific HARQ process locates between the terminal device 210 and the network device 220. In some examples, the specific location may be pre-defined. In some other examples, the specific location may be configured by the network device 220 to the terminal device 210.

In addition or alternatively, the network device 220 may transmit (which is not shown in FIG. 3) a configuration to the terminal device 210, where the configuration may indicate the specific location. In some examples, the configuration indicating the specific location may be the RRC message 302 discussed above. In some other examples, the configuration indication the specific location may be independent from the RRC message 302 discussed above.

In some implementations, the specific location may be the first location in the order, the last location in the order, the mth location in the order, or a middle location in the order. Accordingly, the specific HARQ process may be the first HARQ process in the multiple HARQ processes, the last HARQ process in the multiple HARQ processes, the mth HARQ process in the multiple HARQ processes, or a middle HARQ process in the multiple HARQ processes. For example, m may be an integer which is not larger than N.

In some examples, the middle location may be associate with N/2. In some examples, an order of the middle HARQ process in the multiple HARQ processes may equal to a smallest integer exceeding N/2. In some examples, an order of the middle HARQ process in the multiple HARQ processes may equal to a largest integer not exceeding N/2. In some examples, the middle HARQ process in the multiple HARQ processes may be the nth HARQ process in the multiple HARQ processes, where n=[N/2] or n=[N/2].

In the process 300, the network device 220 transmits 320 information 322 to the terminal device 210, where the information schedules the multiple TBs and indicates the corresponding multiple HARQ processes. In some examples, the information may include a DCI which scheduling multiple TBs.

In some implementations, the information (such as DCI) may include multiple HARQ process IDs in an order, where a specific HARQ process ID is located at a specific location in the order.

In some example embodiments, there is no need to include any HARQ state in the information 322 (such as DCI), in this event, an overhead may be reduced. In some examples, the information 322 includes multiple HARQ process IDs in an order without including any HARQ state.

On the other side of communication, the terminal device 210 receives 324 the information 322 which schedules the multiple TBs and indicates the multiple HARQ processes.

In the process 300, the terminal device 210 determines 330 a configured HARQ state of a specific HARQ process in the multiple HARQ processes.

In some implementations, the terminal device 210 may determine which is the specific HARQ process at a specific location in the multiple HARQ processes. For example, if the specific location is the first one, the terminal device 210 may determine that the specific HARQ process is the first one in the multiple HARQ processes. As an example, it is assumed that the specific HARQ process is HARQ process ID 0.

In some implementations, the terminal device 210 may determine the configured HARQ state of the specific HARQ process, e.g., based on the RRC message 302. For example, the configured HARQ state of HARQ process ID 0 is “HARQ feedback disabling”.

In the process 300, the terminal device 210 determines 340 that all of the multiple HARQ processes indicated by the information 322 have a same HARQ state, i.e., the configured HARQ state of the specific HARQ process. In some examples, the same HARQ state is determined based on the configured HARQ state of the specific HARQ process, while regardless of other N−1 configured HARQ states of other N−1HARQ processes in the multiple HARQ processes.

In some examples, the multiple TBs are scheduled by the DCI for downlink transmission, in this regard, the same HARQ state for all of the multiple TBs may be a HARQ feedback disabling in downlink, or may be a HARQ feedback enabling in downlink.

In some other examples, the multiple TBs are scheduled by the DCI for uplink transmission, in this regard, the same HARQ state for all of the multiple TBs may be a HARQ mode A in uplink, or may be a HARQ mode B in uplink.

In addition or alternatively, a scheduled transmission may be further performed at 350. In some examples, a DRX related operation may be performed based on the same HARQ state for all of the multiple TBs.

According to some embodiments described above, a solution for determining the HARQ state for all scheduled TBs in multi-TB scheduling using only RRC configuration (i.e., option1 only) as HARQ feedback disabling/enabling is proposed. Specifically, when multiple TBs are scheduled, a rule for determining the HARQ state for all HARQ processes associated with multi-TB scheduling may be defined. With this solution, the network device 220 may can flexibly inform the terminal device 210 on the same HARQ state (i.e., HARQ feedback disabling/enabling) for all scheduled TBs and provide the flexibility on scheduling as well as simplify the DRX operation with one unified solution for different HARQ state indication solution.

FIG. 4 illustrates an example of a process flow 400 in accordance with some example embodiments of the present disclosure. For the purpose of discussion, the process flow 400 will be described with reference to FIG. 2. The process flow 400 involves the terminal device 210 and the network device 220. It would be appreciated that although the process flow 400 has been described in the network environment 200 of FIG. 2, this process flow may be likewise applied to other communication scenarios.

For ease of description, the process flow 400 is discussed take downlink as an example, in this event, the HARQ state may be a HARQ feedback state, such as HARQ feedback enabling or HARQ feedback disabling. However, it would be appreciated that similar solution may be applied for uplink, where the HARQ state may be a HARQ mode, such as HARQ Mode A or HARQ Mode B.

At 410, the network device 220 may configure HARQ feedback state (enabling or disabling) per HARQ process via a bitmap, the network device 220 may further configure the specific location of a specific HARQ process (such as the first one), which may be used for determining a same HARQ feedback state for all scheduled TBs in one DCI. It is to be understood that the specific location may also be pre-defined.

As an example, it is assumed that 4 HARQ processes have been configured with different HARQ feedback states for eMTC CE mode B as below: HARQ process ID 0: HARQ feedback disabling; HARQ process ID 1: HARQ feedback enabling; HARQ process ID 2: HARQ feedback disabling; and HARQ process ID 3: HARQ feedback enabling.

At 420, the network device 220 may determine the number of multiple TBs scheduled by the DCI, for example, the number may be represented as N, the network device 220 may further determine a HARQ feedback state of all scheduled TBs, for example, the HARQ feedback state of all scheduled TBs is determined as HARQ feedback disabling.

At 420, the network device 220 may further determine a HARQ process (e.g., HARQ process ID 0 or HARQ process ID 2) which has a configured HARQ feedback state which is HARQ feedback disabling, and schedules the HARQ process as the first HARQ process, schedules the next N−1 HARQ processes regardless of the configured N−1 HARQ feedback states.

As an example, if the same HARQ feedback state of all scheduled TBs is determined as HARQ feedback disabling, the multiple HARQ processes may be:
any of {HARQ process ID 0}, or {HARQ process ID 2}, if N=1;
any of {HARQ process ID 0, HARQ process ID 1}, {HARQ process ID 0, HARQ process ID 2}, {HARQ process ID 0, HARQ process ID 3}, or {HARQ process ID 2, HARQ process ID 3}, if N=2;

any of {HARQ process ID 0, HARQ process ID 1, HARQ process ID 2}, {HARQ process ID 0, HARQ process ID 1, HARQ process ID 3}, {HARQ process ID 0, HARQ process ID 2, HARQ process ID 3}, if N=3, or
{HARQ process ID 0, HARQ process ID 1, HARQ process ID 2, HARQ process ID 3}, if N=4.

Comparing to a legacy scheduling that only {HARQ process ID 0}, {HARQ process ID 2}, or {HARQ process ID 0, HARQ process ID 2} can be scheduled, the present disclosure provides a flexibility on scheduling, where there are more options selected by the network device 220, and the scheduling opportunities are extended.

At 430, the network device 220 may transmit a DCI for multi-TB scheduling, e.g., the DCI schedules N TBs for eMTC CE mode B and indicates N HARQ processes, where the first HARQ process is HARQ process ID 0 or HARQ process ID 2.

At 440, the terminal device 210 may determine that a HARQ feedback state for all scheduled TBs in the DCI should be the same, which is a configured HARQ feedback state of the first HARQ process (HARQ process ID 0 or HARQ process ID 2), i.e., HARQ feedback disabling.

According to the embodiments with reference to FIGS. 3-4, there is no limitation on HARQ state (i.e., HARQ feedback disabling/enabling in downlink or HARQ Mode A/B in uplink) configuration for each HARQ process when it is configured via the RRC configuration only. There is also less limitation on scheduling (i.e., the HARQ processes configured with HARQ feedback disabling/enabling or configured with HARQ Mode A/B) in the multi-TB scheduling DCI to select the HARQ processes to be scheduled. In addition, the unified DRX solution can be supported for the different HARQ feedback disabling/enabling (or HARQ Mode A/B) signaling solution, option1 only, option 3 only, and option 1+option3, which will reduce the specification complexity in DRX operation for multi-TB.

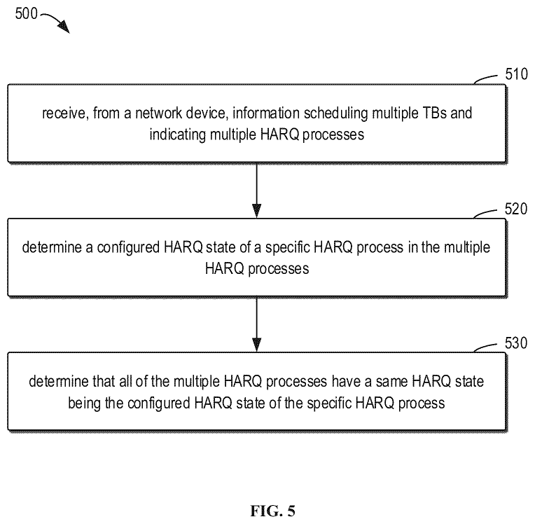

FIG. 5 illustrates a flowchart of a method 500 implemented at a terminal device in accordance with some example embodiments of the present disclosure. For the purpose of discussion, the method 500 will be described from the perspective of the terminal device 210 with reference to FIG. 2.

At block 510, the terminal device 210 receives, from a network device, information scheduling multiple TBs and indicating multiple HARQ processes. At block 520, the terminal device 210 determines a configured HARQ state of a specific HARQ process in the multiple HARQ processes. At block 530, the terminal device 210 determines that all of the multiple HARQ processes have a same HARQ state being the configured HARQ state of the specific HARQ process.

In some example embodiments, the terminal device 210 receives, from the network device, a configuration indicating a specific location of the specific HARQ process.

In some example embodiments, a specific location of the specific HARQ process is predefined.

In some example embodiments, the specific HARQ process is one of: a first HARQ process, a last HARQ process, the mth HARQ process, or a middle HARQ process among the multiple HARQ processes.

In some example embodiments, an order of the middle HARQ process in the multiple HARQ processes is associated with N/2, where N represents a number of the multiple HARQ processes. In some example embodiments, the order of the middle HARQ process in the multiple HARQ processes equals to one of: a smallest integer exceeding N/2, or a largest integer not exceeding N/2.

In some example embodiments, the terminal device 210 receives, from the network device, an RRC message comprising a bitmap indicating a group of configured HARQ states corresponding to a group of HARQ processes.

In some example embodiments, the multiple HARQ processes comprises a further HARQ process different from the specific HARQ process, and where the same HARQ state for all of the multiple HARQ processes is determined regardless of a further configured HARQ state of the further HARQ process.

In some example embodiments, the same HARQ state for all of the multiple HARQ processes is a HARQ feedback disabling or a HARQ feedback enabling in downlink. In some example embodiments, the same HARQ state for all of the multiple HARQ processes is a HARQ Mode A or a HARQ Mode B in uplink.

In some example embodiments, the information comprises a DCI scheduling multi-TB for one of: NB-IoT over NTN, eMTC CE mode A over NTN, eMTC CE mode B over NTN, or NR over NTN.

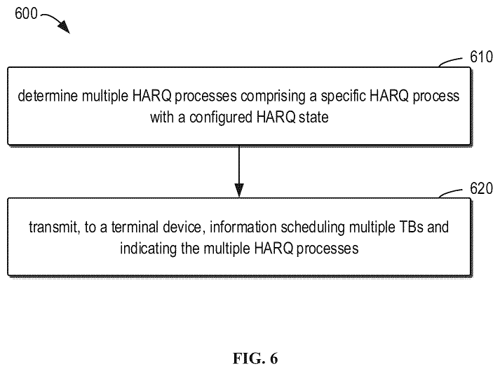

FIG. 6 illustrates a flowchart of a method 600 implemented at a network device in accordance with some example embodiments of the present disclosure. For the purpose of discussion, the method 600 will be described from the perspective of the network device 220 with reference to FIG. 2.

At block 610, the network device 220 determines multiple HARQ processes comprising a specific HARQ process with a configured HARQ state. At block 620, the network device 220 transmits, to a terminal device, information scheduling multiple TBs and indicating the multiple HARQ processes.

In some example embodiments, the network device 220 transmits, to the terminal device, a configuration indicating a specific location of the specific HARQ process.

In some example embodiments, a specific location of the specific HARQ process is predefined.

In some example embodiments, the specific HARQ process is one of: a first HARQ process, a last HARQ process, the mth HARQ process, or a middle HARQ process among the multiple HARQ processes.

In some example embodiments, an order of the middle HARQ process in the multiple HARQ processes is associated with N/2, where N represents a number of the multiple HARQ processes.

In some example embodiments, the order of the middle HARQ process in the multiple HARQ processes equals to one of: a smallest integer exceeding N/2, or a largest integer not exceeding N/2.

In some example embodiments, the network device 220 transmits, to the terminal device, an RRC message comprising a bitmap indicating a group of configured HARQ states corresponding to a group of HARQ processes.

In some example embodiments, a same HARQ state for all of the multiple HARQ processes is determined by the terminal device as the configured HARQ state of the specific HARQ process.

In some example embodiments, the same HARQ state for all of the multiple HARQ processes is a HARQ feedback disabling or a HARQ feedback enabling in downlink.

In some example embodiments, the same HARQ state for all of the multiple HARQ processes is a HARQ Mode A or a HARQ Mode B in uplink.

In some example embodiments, the information comprises a DCI scheduling multi-TB for one of: NB-IoT over NTN, eMTC CE mode A over NTN, eMTC CE mode B over NTN, or NR over NTN.

In some example embodiments, an apparatus capable of performing the method 500 (for example, the terminal device 210) may comprise means for performing the respective steps of the method 500. The means may be implemented in any suitable form. For example, the means may be implemented in a circuitry or software module.

In some example embodiments, the apparatus comprises: means for receiving, from a network device, information scheduling a plurality of TBs and indicating a plurality of HARQ processes; means for determining a configured HARQ state of a specific HARQ process in the plurality of HARQ processes; and means for determining that all of the plurality of HARQ processes have a same HARQ state being the configured HARQ state of the specific HARQ process.

In some example embodiments, the apparatus comprises: means for receiving, from the network device, a configuration indicating a specific location of the specific HARQ process.

In some example embodiments, a specific location of the specific HARQ process is predefined.

In some example embodiments, the specific HARQ process is one of: a first HARQ process, a last HARQ process, the mth HARQ process, or a middle HARQ process among the plurality of HARQ processes.

In some example embodiments, an order of the middle HARQ process in the plurality of HARQ processes is associated with N/2, wherein N represents a number of the plurality of HARQ processes.

In some example embodiments, the order of the middle HARQ process in the plurality of HARQ processes equals to one of: a smallest integer exceeding N/2, or a largest integer not exceeding N/2.

In some example embodiments, the apparatus comprises: means for receiving, from the network device, an RRC message comprising a bitmap indicating a group of configured HARQ states corresponding to a group of HARQ processes.

In some example embodiments, the plurality of HARQ processes comprises a further HARQ process different from the specific HARQ process, and wherein the same HARQ state for all of the plurality of HARQ processes is determined regardless of a further configured HARQ state of the further HARQ process.

In some example embodiments, the configured HARQ state is a HARQ feedback disabling or a HARQ feedback enabling in downlink. In some example embodiments, the configured HARQ state is a HARQ Mode A or a HARQ Mode B in uplink.

In some example embodiments, the information comprises a DCI scheduling multi-TB for one of: NB-IoT over NTN, eMTC CE mode A over NTN, eMTC CE mode B over NTN, or NR over NTN.

In some example embodiments, an apparatus capable of performing the method 600 (for example, the network device 220) may comprise means for performing the respective steps of the method 600. The means may be implemented in any suitable form. For example, the means may be implemented in a circuitry or software module.

In some example embodiments, the apparatus comprises: means for determining a plurality of HARQ processes comprising a specific HARQ process with a configured HARQ state; and means for transmitting, to a terminal device, information scheduling a plurality of TBs and indicating the plurality of HARQ processes.

In some example embodiments, the apparatus comprises: means for transmitting, to the terminal device, a configuration indicating a specific location of the specific HARQ process.

In some example embodiments, a specific location of the specific HARQ process is predefined.

In some example embodiments, the specific HARQ process is one of: a first HARQ process, a last HARQ process, the mth HARQ process, or a middle HARQ process among the plurality of HARQ processes.

In some example embodiments, an order of the middle HARQ process in the plurality of HARQ processes is associated with N/2, wherein N represents a number of the plurality of HARQ processes.

In some example embodiments, the order of the middle HARQ process in the plurality of HARQ processes equals to one of: a smallest integer exceeding N/2, or a largest integer not exceeding N/2.

In some example embodiments, the apparatus comprises: means for transmitting, to the terminal device, an RRC message comprising a bitmap indicating a group of configured HARQ states corresponding to a group of HARQ processes.

In some example embodiments, a same HARQ state for all of the plurality of HARQ processes is determined by the terminal device as the configured HARQ state of the specific HARQ process.

In some example embodiments, the configured HARQ state is a HARQ feedback disabling or a HARQ feedback enabling in downlink. In some example embodiments, the configured HARQ state is a HARQ Mode A or a HARQ Mode B in uplink.

In some example embodiments, the information comprises a DCI scheduling multi-TB for one of: NB-IoT over NTN, eMTC CE mode A over NTN, eMTC CE mode B over NTN, or NR over NTN.

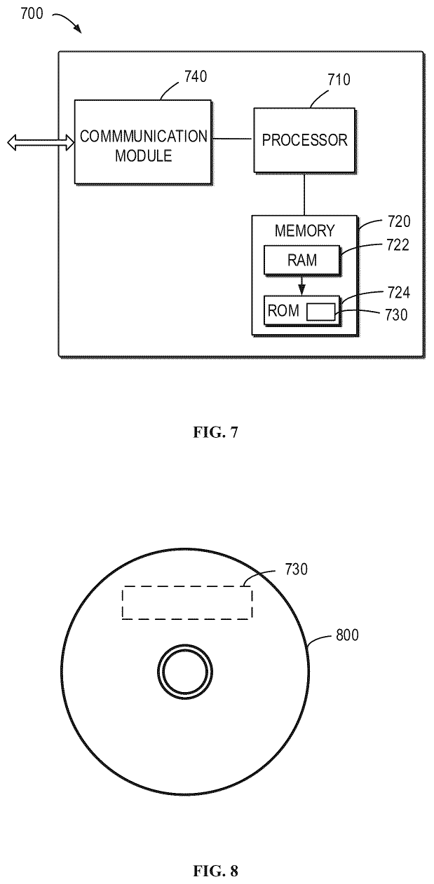

FIG. 7 illustrates a simplified block diagram of a device 700 that is suitable for implementing some example embodiments of the present disclosure. The device 700 may be provided to implement the communication device, for example the terminal device 210 and the network device 220 as shown in FIG. 2. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 3-6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 3-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-27. (canceled)

28. A terminal device comprising:
at least one processor; and
at least one memory storing instructions that, when executed by the at least one processor, cause the terminal device at least to:
receive, from a network device, information scheduling a plurality of transport blocks (TBs) and indicating a corresponding plurality of hybrid automatic repeat request (HARQ) processes;
determine a configured HARQ state of a specific HARQ process in the plurality of HARQ processes; and
determine that all of the plurality of HARQ processes have a same HARQ state being the configured HARQ state of the specific HARQ process.

29. The terminal device of claim 28, wherein the terminal device is further caused to: receive, from the network device, a configuration indicating a specific location of the specific HARQ process.

30. The terminal device of claim 28, wherein a specific location of the specific HARQ process is predefined.

31. The terminal device of claim 28, wherein the specific HARQ process is one of: a first HARQ process, a last HARQ process, the mth HARQ process, or a middle HARQ process among the plurality of HARQ processes.

32. The terminal device of claim 31, wherein an order of the middle HARQ process in the plurality of HARQ processes is associated with N/2, wherein N represents a number of the plurality of HARQ processes.

33. The terminal device of claim 32, wherein the order of the middle HARQ process in the plurality of HARQ processes equals to one of:
a smallest integer exceeding N/2, or
a largest integer not exceeding N/2.

34. The terminal device of claim 28, wherein the terminal device is further caused to:
receive, from the network device, a radio resource control (RRC) message comprising a bitmap indicating a group of configured HARQ states corresponding to a group of HARQ processes.

35. The terminal device of claim 28, wherein the plurality of HARQ processes comprises a further HARQ process different from the specific HARQ process, and wherein the same HARQ state for all of the plurality of HARQ processes is determined regardless of a further configured HARQ state of the further HARQ process.

36. The terminal device of claim 28, wherein the configured HARQ state is a HARQ feedback disabling or a HARQ feedback enabling in downlink.

37. The terminal device of claim 28, wherein the configured HARQ state is a HARQ feedback Mode A or a HARQ Mode B in uplink.

38. The terminal device of claim 28, wherein the information comprises downlink control information (DCI) scheduling multi-TB for one of:
narrow band internet of things (NB-IoT) over non-terrestrial network (NTN),
enhanced machine type communication (eMTC) coverage enhancement (CE) mode A over NTN,
eMTC CE mode B over NTN, or
new radio (NR) over NTN.

39. A network device comprising:
at least one processor; and
at least one memory storing instructions that, when executed by the at least one processor, cause the network device at least to:
determine a plurality of hybrid automatic repeat request (HARQ) processes comprising a specific HARQ process with a configured HARQ state; and
transmit, to a terminal device, information scheduling a plurality of transport blocks (TBs) and indicating the plurality of HARQ processes.

40. The network device of claim 39, wherein the network device is further caused to:
transmit, to the terminal device, a configuration indicating a specific location of the specific HARQ process.

41. The network device of claim 39, wherein a specific location of the specific HARQ process is predefined.

42. The network device of claim 39, wherein the specific HARQ process is one of: a first HARQ process, a last HARQ process, the mth HARQ process, or a middle HARQ process among the plurality of HARQ processes.

43. The network device of claim 42, wherein an order of the middle HARQ process in the plurality of HARQ processes is associated with N/2, wherein N represents a number of the plurality of HARQ processes.

44. The network device of claim 43, wherein the order of the middle HARQ process in the plurality of HARQ processes equals to one of:
a smallest integer exceeding N/2, or
a largest integer not exceeding N/2.

45. The network device of claim 39, wherein the network device is further caused to:
transmit, to the terminal device, a radio resource control (RRC) message comprising a bitmap indicating a group of configured HARQ states corresponding to a group of HARQ processes.

46. The network device of claim 39, wherein a same HARQ state for all of the plurality of HARQ processes is determined by the terminal device as the configured HARQ state of the specific HARQ process.

47. A method comprising:
receiving, at a terminal device from a network device, information scheduling a plurality of transport blocks (TBs) and indicating a plurality of hybrid automatic repeat request (HARQ) processes;
determining a configured HARQ state of a specific HARQ process in the plurality of HARQ processes; and
determining that all of the plurality of HARQ processes have a same HARQ state being the configured HARQ state of the specific HARQ process.
